(19) United States
(12) Patent Application Publication
(10) Pub. No.: US 2023/0259173 A1
(43) Pub. Date: Aug. 17, 2023

(54) PROTECTIVE FILM AND ELECTRONIC DEVICE INCLUDING SAME

(71) Applicant: Samsung Electronics Co., Ltd., Suwon-si (KR)

(72) Inventors: Taedoo CHOUNG, Suwon-si (KR); Byounguk YOON, Suwon-si (KR); Jeeyoung OH, Suwon-si (KR); Seungwoo YOO, Suwon-si (KR); Jongsu LEE, Suwon-si (KR); Hoyoung LEE, Suwon-si (KR)

(21) Appl. No.: 18/178,067

(22) Filed: Mar. 3, 2023

Related U.S. Application Data
(63) Continuation of application No. PCT/KR2023/001790, filed on Feb. 8, 2023.

(30) Foreign Application Priority Data
Feb. 14, 2022 (KR) 10-2022-0019141
Apr. 7, 2022 (KR) 10-2022-0043422

(51) Int. Cl. G06F 1/16; H04M 1/02

(52) U.S. Cl. CPC G06F 1/1656; G06F 1/1624; G06F 1/1681; G06F 1/1616; H04M 1/0237; H04M 1/0216

(57) ABSTRACT

An electronic device is provided. The electronic device includes a first housing, a second housing connected to the first housing such that a relative position thereof with respect to the first housing is changeable, a display including a window layer and a display panel disposed under the window layer and including a deformation area deformed as the relative position between the first housing and the second housing is changed, a substrate layer which includes a pattern in which multiple protrusions repeat and is disposed above the window layer, and an adhesive layer which is disposed between the window layer and the substrate layer such that at least a part thereof is disposed between the protrusions of the substrate layer, and has a refractive index adjustment member mixed therein in order to reduce a refractive index difference with the substrate layer.

### CROSS-REFERENCE TO RELATED APPLICATION(S)

This application is a continuation application, claiming priority under § 365(c), of an International application No. PCT/KR2023/001790, filed on Feb. 8, 2023, which is based on and claims the benefit of a Korean patent application number 10-2022-0019141, filed on Feb. 14, 2022, in the Korean Intellectual Property Office, and of a Korean patent application number 10-2022-0043422, filed on Apr. 7, 2022, in the Korean Intellectual Property Office, the disclosure of each of which is incorporated by reference herein in its entirety.

### TECHNICAL FIELD

The disclosure relates to a protective film and an electronic device including the protective film.

### BACKGROUND ART

With the recent development of display technologies, flexible displays have been released to the market. Such a flexible display may be used to implement a display having a size-changeable screen. For example, electronic devices of a new concept, which include a display of which the screen size increases or decreases through sliding, a display rollable on a specific mechanical element, or a display deformable through folding, have also been developed.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

A protective film for protecting the surface of a display may be attached to a rollable or a foldable flexible display. The protective film may include a substrate layer and an adhesive layer for attaching the substrate layer to the display. The substrate layer may be formed of a hard material to reduce damage to the display.

In addition, as the substrate layer is formed of a hard material, a repulsive force generated in the substrate layer during rolling or folding thereof may be greater than that of the case in which the substrate layer is formed of a soft material. As a display is coupled to the substrate layer through the adhesive layer, the shape of the display may be deformed due to the repulsive force of the substrate layer, or the operation such as rolling or folding may be interrupted.

Aspects of the disclosure are to address at least the above-mentioned problems and/or disadvantages and to provide at least the advantages described below. Accordingly, an aspect of the disclosure is to provide a substrate layer, of a protective film, that is formed of a hard material and formed to have a low repulsive force. Therefore, it may be possible to alleviate the shape deformation of a display or the phenomenon that the operation such as rolling or folding is interrupted due to a repulsive force of the substrate layer.

Additional aspects will be set forth in part in the description which follows and in part, will be apparent from the description, or may be learned by practice of the presented embodiments.

### Solution to Problem

In accordance with an aspect of the disclosure, an electronic device is provided. The electronic device includes a first housing, a second housing connected to the first housing such that a relative position thereof with respect to the first housing is changeable, a display including a window layer and a display panel disposed under the window layer and including a deformation area deformed as the relative position between the first housing and the second housing is changed, a substrate layer which includes a pattern in which multiple protrusions repeat and is disposed above the window layer, and an adhesive layer which is disposed between the window layer and the substrate layer such that at least a part thereof is disposed between the protrusions of the substrate layer, and has a refractive index adjustment member mixed therein in order to reduce a refractive index difference with the substrate layer.

In accordance with another aspect of the disclosure, a protective film disposed on a display of an electronic device is provided. The protective film includes a substrate layer which includes a pattern in which multiple protrusions repeat and is disposed above a window layer of the display, and an adhesive layer which is disposed between the window layer and the substrate layer such that at least a part thereof is disposed between the protrusions of the substrate layer, and has a refractive index adjustment member mixed therein in order to reduce a refractive index difference with the substrate layer.

### Advantageous Effects of Invention

According to various embodiments disclosed in the document, a substrate layer of a protective film may be formed of a hard material and have a low a repulsive force. Therefore, it may be possible to alleviate the shape deformation of a display or the phenomenon that the operation such as rolling or folding is interrupted due to a repulsive force of the substrate layer.

In addition, it may be possible to reduce a refractive index difference between the substrate layer and the adhesive layer of the protective film through the adhesive layer.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2A is a perspective view showing a closed state of an electronic device according to an embodiment of the disclosure;

FIG. 2B is a perspective view showing an open state of an electronic device according to an embodiment of the disclosure;

FIG. 2C is an exploded perspective view of an electronic device according to an embodiment of the disclosure;

FIG. 3A is a cross-sectional view of the electronic device taken along line A-A illustrated in FIG. 2A according to an embodiment of the disclosure;

FIG. 3B is a cross-sectional view of the electronic device taken along line B-B illustrated in FIG. 2B according to an embodiment of the disclosure;

FIG. 4 is an exploded perspective view of a display according to an embodiment of the disclosure;

FIG. 5 is a view for explaining display deformation which may occur in the process in which a display is slid according to an embodiment of the disclosure;

FIG. 6A is a cross-sectional view of the electronic device taken along line A-A illustrated in FIG. 2A according to an embodiment of the disclosure;

FIG. 6B is a graph for explaining a relationship between a projection degree of a pattern formed on a substrate layer and a wavelength of light according to an embodiment of the disclosure;

FIG. 7 is a view showing various shapes of a pattern formed on a substrate layer of a protective film according to an embodiment of the disclosure;

FIG. 8A is a rear perspective view of a protective film according to an embodiment of the disclosure;

FIG. 8B is a cross-sectional view of the protective film taken along line C-C illustrated in FIG. 8A according to an embodiment of the disclosure;

FIG. 8C is a rear perspective view of the protective film illustrated in FIG. 8A and a protective film of according to an embodiment of the disclosure;

FIG. 9A is a view showing an unfolded state of an electronic device according to according to an embodiment of the disclosure;

FIG. 9B is a view showing an intermediate state between an unfolded state and a folded state of an electronic device according to an embodiment of the disclosure; and

FIG. 9C is a rear perspective view of the protective film for protecting a display illustrated in FIG. 9A according to an embodiment of the disclosure.

Throughout the drawings, it should be noted that like reference numbers are used to depict the same or similar elements, features, and structures.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

With regard to the description of the drawings, similar reference numerals may be used to refer to similar or related elements.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1^{st}” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it denotes that the element may be coupled with the other element directly (e.g., wiredly), wirelessly, or via a third element.

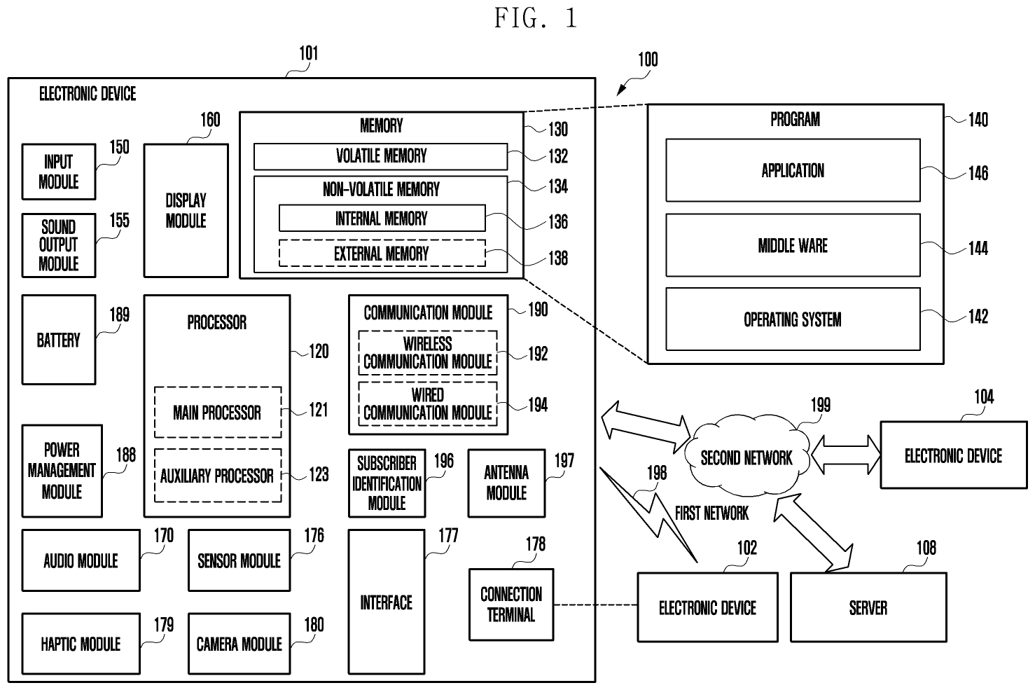

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connection terminal 178, a haptic module 179, a camera module 180, a power management module 188, a battery 189, a communication module 190, a subscriber identification module (SIM) 196, or an antenna module 197. In some embodiments, at least one of the components (e.g., the connection terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134. The non-volatile memory 134 may include an internal memory 136 and an external memory 138.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., the electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

The connection terminal 178 may include a connector via which the electronic device 101 may be physically connected with the external electronic device (e.g., the electronic device 102). According to an embodiment, the connection terminal 178 may include, for example, a HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5th generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4th generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter Wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102 and 104 or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

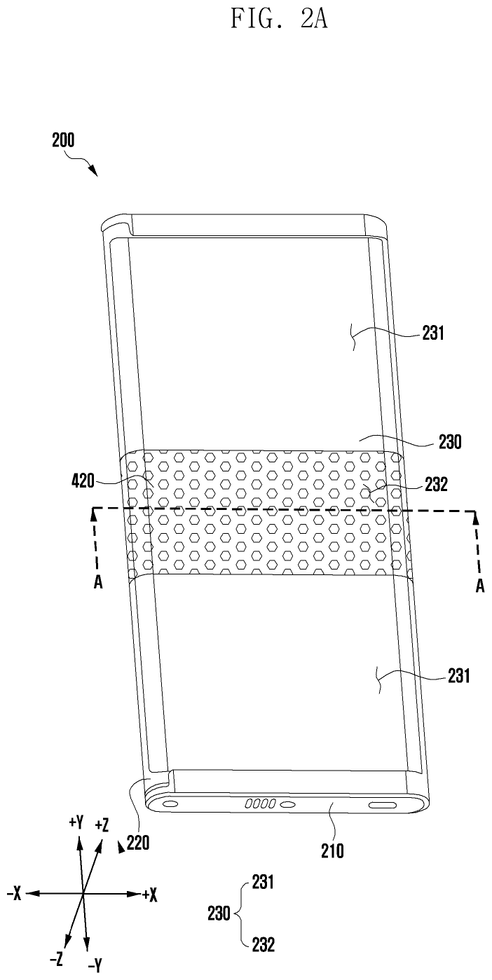

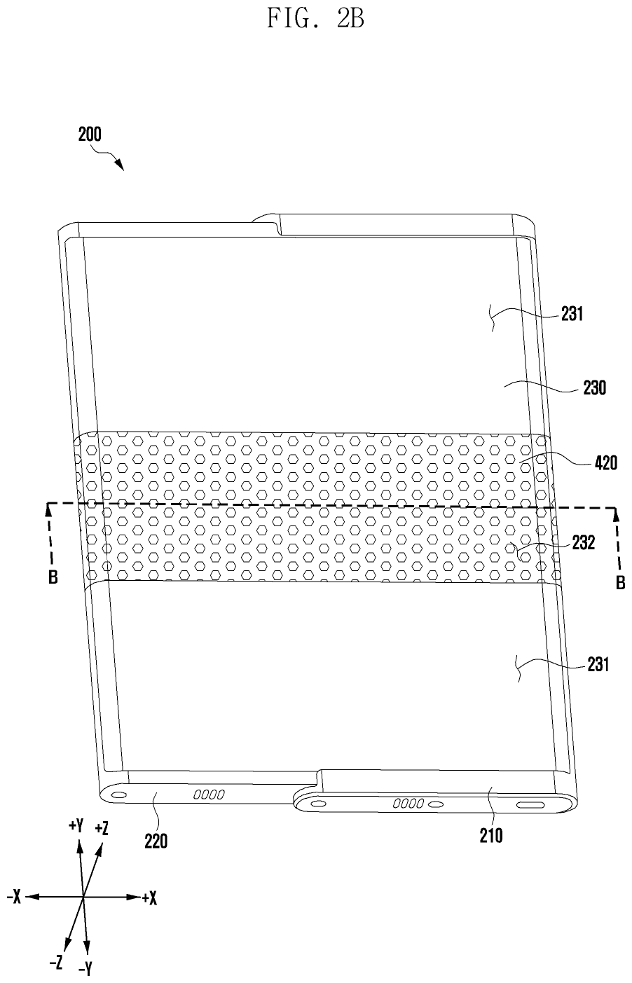

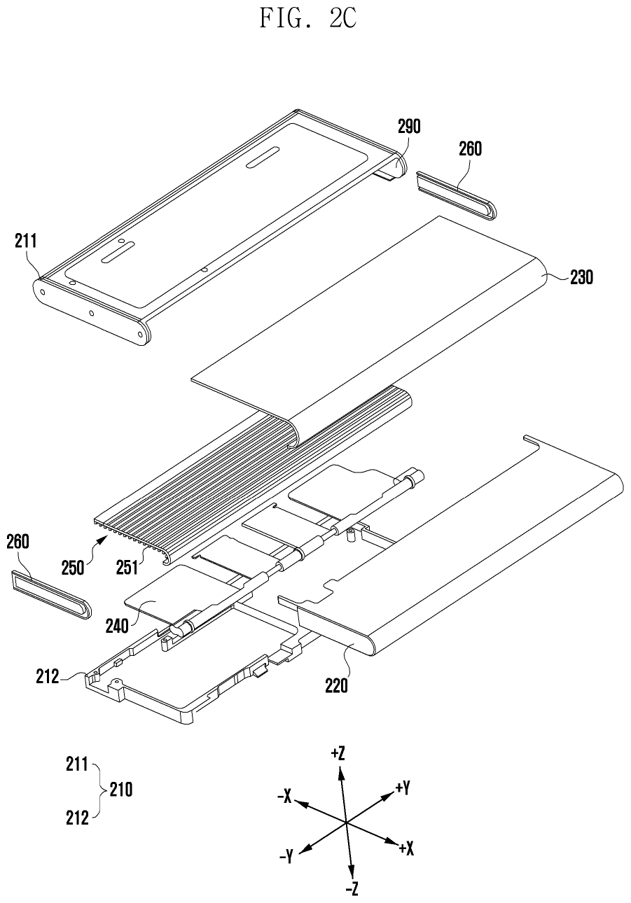

FIG. 2A is a perspective view showing a closed state of an electronic device according to an embodiment of the disclosure. FIG. 2B is a perspective view showing an open state of an electronic device according to an embodiment of the disclosure. FIG. 2C is an exploded perspective view of an electronic device according to an embodiment of the disclosure.

According to various embodiments, an electronic device 200 illustrated in FIGS. 2A to 2C may be one of the electronic devices 101 described in FIG. 1. The electronic device described below may include at least one of the elements described in FIG. 1.

Referring to FIGS. 2A and 2B, an electronic device 200 may be configured to be slidable. In an embodiment, a sliding operation of the electronic device 200 may mean sliding of a second housing 220 with respect to a first housing 210. The second housing 220 may be slid with respect to the first housing 210 in the +X-direction with reference to FIGS. 2A and 2B or the −X-direction with reference to FIGS. 2A and 2B. In the description below, the operation, in which the second housing 220 slides in the +X-direction, is defined as a slide-in, and the operation, in which the second housing 220 slides in the −X-direction, is defined as a slide-out.

The electronic device 200 according to various embodiments disclosed in the document may be the electronic device 200 implemented such that an area of a display 230 (e.g., the display module 160 in FIG. 1), which is visually exposed to the outside of the electronic device 200 through a sliding manner, increases or decreases. In case of being understood differently, the electronic device 200 may be an electronic device configured such that a part of the display 230 is inserted into the electronic device 200 or withdrawn from the inside of the electronic device 200 through a sliding manner.

According to various embodiments, the display 230 may be a flexible display 230 which is bendable. In an embodiment, the display 230 may include a substrate made of a flexible material. For example, the display 230 may include a substrate formed of a polymer material made of a flexible material such as polyimide (PI) or polyethylene terephthalate (PET). In addition, the display may include a substrate made of a glass material formed very thin. The display 230 may be supported by a support member 250, and may have an area which is a portion seen to the outside and is increasable or decreasable according to sliding of the second housing 220 with respect to the first housing 210. In an embodiment, the display 230 may further include a touch sensing circuit (e.g., a touch sensor). In addition, the display 230 may be coupled or adjacently disposed to a pressure sensor capable of measuring the intensity (pressure) of touch, and/or a digitizer for detecting a magnetic field type pen input device (a stylus pen). For example, the digitizer may include a coil member disposed on a dielectric substrate to be able to detect the resonance frequency of an electromagnetic induction method, which is applied from the pen input device.

According to various embodiments, a state of the electronic device 200 may be changed from a closed state (e.g., the state illustrated in FIG. 2A) to an open state (e.g., the state illustrated in FIG. 2B) by a sliding operation.

A closed state may mean a state in which the second housing 220 is fully slid in. The closed state may mean a state in which the second housing 220 has reached a position in which the second housing may no longer slide in. In the closed state, the ends of the first housing 210 and the end of the second housing 220 may be substantially coincident. For example, as illustrated in FIG. 2A, the second housing 220 may protrude with respect to the first housing 210, or the first housing 210 may not protrude with respect to the second housing 220.

An open state may mean a state in which the second housing 220 is fully slid out. The open state may mean a state in which the second housing 220 has reached a position in which the second housing may no longer slide out. The area of the display 230, which is visually exposed from the outside, may be larger in the open state than in the closed state.

According to an embodiment, sliding of the second housing 220 with respect to the first housing 210 may be performed semi-automatically. For example, sliding of the second housing 220 with respect to the first housing 210 may be performed by a member (not shown) for providing an elastic force in the sliding direction thereof. In this case, in case that sliding of the second housing 220 with respect to the first housing 210 is partially achieved, sliding of the second housing 220 may be achieved by an elastic force provided to the first housing 210 and/or the second housing 220.

According to an embodiment, sliding of the second housing 220 with respect to the first housing 210 may be performed automatically. For example, the second housing 220 may be slid with respect to the first housing 210 by a motor (not shown). The motor, which slides the second housing 220, may be operated according to a signal input through various buttons and sensors included in the electronic device 200.

According to various embodiments, a protective film 400 for protecting the display 230 may be disposed on the display 230. The protective film 400 may protect the display 230 from an external force. The protective film 400 may include a substrate layer 410 formed of a hard material and exposed to the surface of the electronic device 200 and an adhesive layer 430 formed of a soft material and disposed between the substrate layer 410 and the display 230. The substrate layer 410 may be attached to the display 230 through the adhesive layer 430. Referring to FIGS. 2A and 2B, a pattern 420 may be formed on the substrate layer 410 of the protective film 400. The substrate layer 410 may have multiple grooves 421 (e.g., micro-grooves) formed on the rear surface (e.g., the surface oriented in the −Z-direction with reference to FIG. 2A) thereof so as to reduce a repulsive force thereof, and thus may become more flexible. Accordingly, the protective film 400 may be flexibly bent together with the display 230.

According to various embodiments, the first housing 210 may include multiple housings. Since the second housing 220 slides with respect to the first housing 210, it may be understood that the second housing 220 slides with respect to the multiple housings included in the first housing 210. For example, the multiple housings included in the first housing 210 may include a front housing 211 constituting a part of the front surface (e.g., the surface oriented in the +Z-direction in FIG. 2A) of the electronic device 200 and a rear housing 212 constituting a part of the rear surface (e.g., the surface oriented in the −Z-direction in FIG. 2A) of the electronic device 200. A rear cover (not shown) may be coupled to the rear housing 212. The rear cover may be formed of a transparent, an opaque, or a translucent material. A part of the second housing 220 may be accommodated in a space formed by the multiple housings included in the first housing 210. The element of the first housing 210 illustrated in FIG. 2C may be merely an example, and the first housing 210 may be configured by a single housing or may also include a greater number of housings than that illustrated in FIG. 2C.

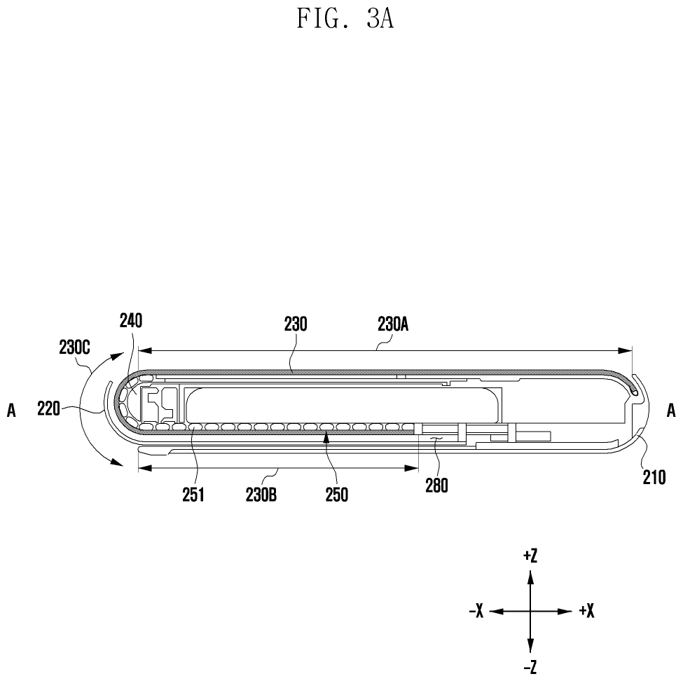

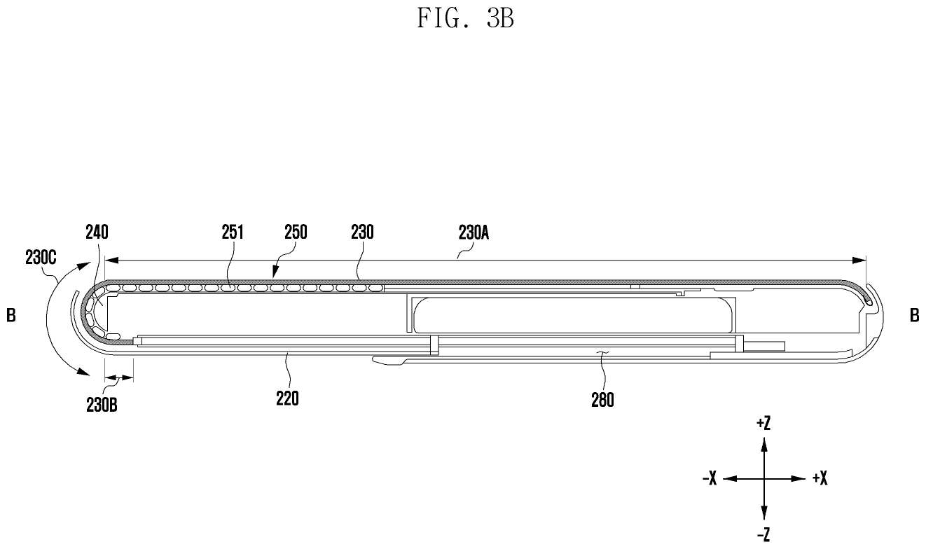

According to various embodiments, the second housing 220 may be slid with respect to the first housing 210. Referring to FIGS. 2A and 2C, parts of the second housing 220 may be inserted into sliding grooves 290 of the first housing 210 so that the second housing 220 may be guided. A support housing 240 may be coupled to the second housing 220. The support housing 240 may be a housing which supports the support member 250 for supporting the display 230. An accommodation space (e.g., an accommodation space 280 in FIGS. 3A and 3B) may be formed between the support housing 240 and the second housing 220 by coupling of the support housing 240 and the second housing 220. As the second housing 220 slides, a part of the display 230 may be accommodated in the accommodation space provided between the second housing 220 and the support housing 240. In some embodiments, the second housing 220 and the support housing 240 may be integrally formed.

According to various embodiments, the support member 250 may support a part of the display 230. The support member 250 may include a bendable structure. For example, the support member 250 may include a structure in which multiple bars 251 extending in a direction (e.g., the Y-axis direction with reference to FIG. 2C) perpendicular to the sliding direction (e.g., the X-axis direction with reference to FIG. 2C) thereof are arranged along the sliding direction. In addition, the support member 250 may include various bendable structures. For example, the support member 250 may be a bendable plate, and may have a structure in which multiple grooves are formed to allow bending.

According to various embodiments, the support member 250 may be slid according to sliding of the second housing 220 and may support the display 230. Sliding of the support member 250 may be guided by guide rails 260. For example, both ends of the multiple bars 251 included in the support member 250 may be inserted into the guide rails 260, respectively, so that sliding of the support member 250 is be guided. The guide rails 260 for guiding the support member 250 may be coupled to the second housing 220. For example, as illustrated in FIG. 2C, the guide rails 260 may be coupled to opposite ends of the second housing 220, and the support member 250 may be disposed between the guide rails 260.

FIG. 3A is a cross-sectional view of the electronic device taken along line A-A illustrated in FIG. 2A according to an embodiment of the disclosure. FIG. 3B is a cross-sectional view of the electronic device taken along line B-B illustrated in FIG. 2B according to an embodiment of the disclosure.

Referring to FIGS. 3A and 3B, according to various embodiments, the display 230 may include multiple areas. The multiple areas described below may be areas divided according to the state of the display 230 or the portion in which the display 230 is positioned, in the electronic device 200. For example, the display 230 may include an exposure area 230A which is an area in which the display 230 is visually exposed to the outside of the electronic device 200, a storage area 230B which is an area in which the display 230 is accommodated in an accommodation space of the electronic device 200, and a deformation area 230C which is an area configured to connect the exposure area 230A and the storage area 230B and be deformed (e.g., bending). In an embodiment, the storage area 230B of the display 230 may be an area in which a part of the display 230 is accommodated in the accommodation space 280. The accommodation space 280 may be a space surrounded by various mechanical elements constituting the electronic device 200. In an embodiment, the accommodation space 280 may include an area formed by the second housing 220 and a support housing (e.g., the support housing 240 in FIG. 2C). In an embodiment, depending on the shape of a housing surrounding the display 230, a part of the deformation area 230C may also be seen to the outside the electronic device 200. For example, as illustrated in FIGS. 3A and 3B, a part of the second housing 220 may cover the bending area. Accordingly, a part of the deformation area 230C, which is not covered by the second housing 220, may also be exposed to the outside of the electronic device 200. Each area of the display 230 described above is merely divided for convenience of description, and may not be an area which is actually visually distinguished.

In an embodiment, the deformation area 230C may be an area in which a part of the display 230 is deformed to correspond to the outer shape of the second housing 220. For example, as illustrated in FIGS. 3A and 3B, a part of the outer shape of the second housing 220 may include a round shape. The deformation area 230C may be an area in which a part of the display 230 is bent to correspond to the round shape of the second housing 220.

In an embodiment, the display 230 may be supported by the support member 250. Sliding of the support member 250 may be guided by the guide rails 260. The guide rails 260 may be formed to correspond to the round shape of the second housing 220 such that the support member 250 supports the deformation area 230C, and the support member 250 may be bent along the guide rails 260 corresponding to the round shape. For example, in case that the support member 250 includes the multiple bars 251, the gaps between the multiple bars 251 in the portion for supporting the deformation area 230C may be more spaced, compared to those of the portions for supporting the exposure area 230A or the storage area 230B of the display 230, and thus the support member 250 may be bent as a whole. The support member 250 may support the deformation area 230C of the display 230 in a state bent along the guide rails 260.

As the electronic device 200 slides, the sizes of the exposure area 230A and the storage area 230B may be changed. For example, the size of the exposure area 230A in a closed state (e.g., the state illustrated in FIG. 2A) may be smaller than the size of the exposure area 230A in an open state (e.g., the state illustrated in FIG. 2B). The size of the storage area 230B in a closed state may be larger than the size of the storage area 230B in an open state.

According to various embodiments, in case that the second housing 220 slides out, the display 230 supported by the support member 250 may slide so that the exposure area 230A increases and the storage area 230B decreases.

According to various embodiments, in case that the second housing 220 slides in, the display 230 supported by the support member 250 may slide so that the exposure area 230A decreases and the storage area 230B increases.

In the electronic device 200 according to various embodiments disclosed in the document, a part of the display 230 may be inserted into the accommodation space 280 or withdrawn from the accommodation space 280, so that the area of the display 230 seen from the outside of the electronic device 200 may increase or decrease. As the area of the display 230 seen from the outside changes, various operations such as adjusting the amount of information displayed thereon or adjusting the aspect ratio of the content displayed thereon may be performed.

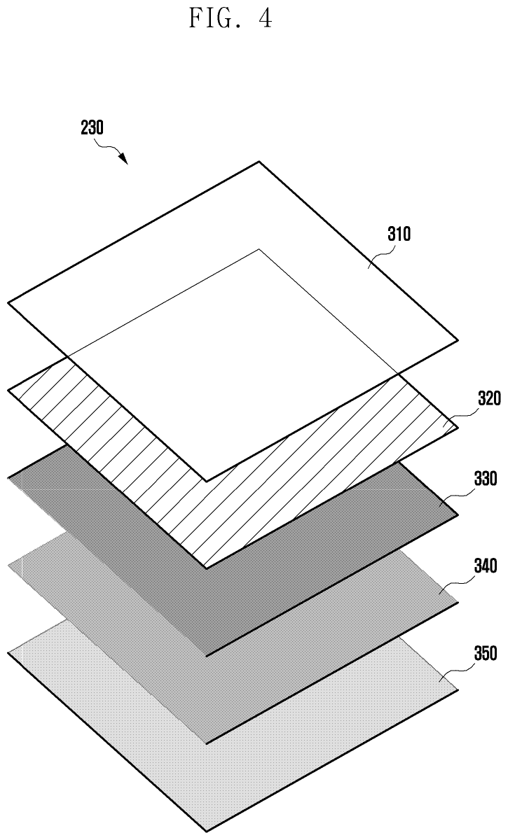

FIG. 4 is an exploded perspective view of a display according to an embodiment of the disclosure.

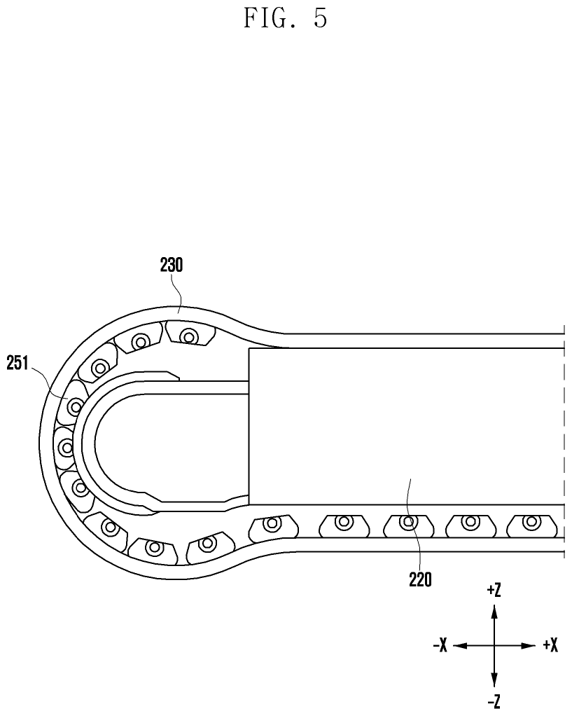

FIG. 5 is a view for explaining display deformation which may occur in the process in which a display is slid according to an embodiment of the disclosure.

The display 230 (e.g., the display module 160 in FIG. 1 or the display 230 in FIG. 2A) according to various embodiments disclosed in the document may include an unbreakable (UB) type OLED display (e.g., a curved display). However, it is not be limited thereto, and the display 230 may include a flat type display having an on-cell touch (OCTA) active matrix organic light-emitting diode (AMOLED) manner.

Referring to FIG. 4, according to various embodiments, the display 230 may include a window layer 310, and a polarizer (POL) 320 (e.g., a polarization film), a display panel 330, a polymer layer 340, and a support plate 350 (e.g., the support member 250 in FIG. 2C) which are sequentially arranged under the window layer 310. In some embodiments, the display 230 may include a digitizer panel disposed under the support plate 350. In some embodiments, the digitizer panel may be disposed between the polymer layer 340 and the support plate 350.

According to various embodiments, the window layer 310 may include a glass layer. According to an embodiment, the window layer 310 may include an ultra-thin glass (UTG). In some embodiments, the window layer 310 may also include polymer. In the case, the window layer 310 may include polyethylene terephthalate (PET) or polyimide (PI). In some embodiments, the window layer 310 may also be disposed as multiple layers to allow a glass layer and polymer to be included therein.

According to various embodiments, the display panel 330 may include multiple pixels and a wire structure. According to an embodiment, the polarizer 320 may allow light, which is generated from a light source of the display panel 330 and vibrates in a predetermined direction, to selectively pass therethrough. According to an embodiment, the display panel 330 and the polarizer 320 may also be integrally formed. According to an embodiment, the display 230 may also include a touch panel (not shown).

According to various embodiments, the polymer layer 340 may be disposed under the display panel 330 to provide a dark background for securing visibility of the display panel 330, and may be formed of a buffer material for a buffer function. In some embodiments, in order to waterproof the display 230, the polymer layer 340 may be removed or may be disposed under the support plate 350.

According to various embodiments, the support plate 350 may provide a flexural characteristic to the display 230. For example, the support plate 350 may be formed of a non-metal thin plate-shaped material for supporting the display panel 330, such as fiber reinforced plastics (FRP) (e.g., carbon fiber reinforced plastics (CFRP) or glass fiber reinforced plastics (GFRP)) having a rigid characteristic. In some embodiments, the support plate 350 may also be formed of a metal material such as steel use stainless (SUS) (e.g., stainless steel (STS)), Cu, Al, or metal CLAD (e.g., a stacking member in which SUS and Al are alternately arranged). The support plate 350 may be used in order to help stiffness reinforcement of the electronic device 200 (e.g., the electronic device 101 in FIG. 1), to shield ambient noise, and to disperse heat emitted from a heat-emitting component therearound.

According to various embodiments, the display 230 may include a digitizer panel which is disposed under the support plate 350 and is a detection member configured to receive an input of an electronic pen (e.g., a stylus). According to an embodiment, the digitizer panel may include coil members which are arranged on a dielectric substrate (e.g., a dielectric film or a dielectric sheet) so as to detect a resonance frequency of an electromagnetic induction type, which is applied from the electronic pen.

According to various embodiments, the protective film 400 (a protective layer) may be disposed on the upper part (e.g., the surface oriented in the +Z-direction with reference to FIG. 2A) of the window layer 310 of the display 230. As described above, the window layer 310 may be formed of UTG and/or polymer and thus may be bent or folded. The window layer 310 may be damaged by an external force in case of being exposed to the surface of the electronic device 200 as it is. Accordingly, the protective film 400 may be disposed on the upper part of the window layer 310 so as to protect the window layer 310 from an external force.

According to various embodiments, the protective film 400 may include the substrate layer 410 and the adhesive layer 430. The substrate layer 410 may be a layer exposed on the surface of the electronic device 200. In addition, the substrate layer 410 may be a layer to which the adhesive layer 430 is attached. The substrate layer 410 may be formed of a hard material having stiffness of a predetermined level or higher such that durability against an external force is secured. For example, even in case that a user uses the electronic pen on the surface of the substrate layer 410, the surface of the substrate layer 410 may not be damaged (e.g., scratched). The substrate layer 410 may be formed of a hard material such as polyethylene terephthalate (PET), thermal plastic polyurethane (TPU), polyurethane (PU), and polyimide (PI). The adhesive layer 430 may be disposed between the substrate layer 410 and the window layer 310 in order to attach the substrate layer 410 to the window layer 310. The adhesive layer 430 may be formed of a soft material such as an acrylic-based material, a silicone-based material, a rubber-based material, and a urethane-based material so as to be bendable. In addition, the adhesive layer 430 may include at least one of an optical clear adhesive (OCA), an optical clear resin (OCR), a pressure sensitive adhesive (PSA), a general adhesive, or a double-sided tape.

Meanwhile, in case that the display 230 is bent or folded, a repulsive force to be restored to the original shape thereof may be generated in the substrate layer 410. The magnitude of a repulsive force may be greater in the case that the substrate layer 410 is formed of a hard material than in the case that the substrate layer 410 is formed of a soft material. In this case, a repulsive force of the substrate layer 410 may interrupt an operation in which the display 230 is bent or folded. In addition, a repulsive force may change the shape of the display 230 coupled to the substrate layer 410 and the shape of the support member 250 coupled to the display 230.

Referring to FIG. 5, in an embodiment, a repulsive force of the substrate layer 410 may deform the central portion of the multiple bars 251 included in the support member 250. Accordingly, the display 230 coupled to the support member 250 may be deformed and thus a lifting phenomenon may occur. For example, since both ends of the multiple bars 251 are fixed to the guide rails 260, the central portion of the multiple bars 251 may be bent convexly in one direction (e.g., the +Z-direction with reference to FIG. 5) due to a repulsive force of the substrate layer 410. Therefore, the lifting phenomenon in which a portion of the display 230 supported by the multiple bars 251 protuberates convexly in a specific direction compared to the other portions may occur.

In some embodiments, a repulsive force of the substrate layer 410 may cause deformation of the protective film 400 and the display 230. For example, the substrate layer 410, the adhesive layer 430, and the display 230 may be a structure stacked in the order thereof. In case that the display 230 is bent or folded in the deformation area 203C through a sliding operation of the electronic device 200, a repulsive force to be restored to the original shape thereof may be generated in the substrate layer 410. In this case, a repulsive force generated in the substrate layer 410 may cause deformation in the substrate layer 410, the adhesive layer 430, and the display 230. Accordingly, the display 230 may be lifted or bent together with the protective film 400.

The protective film 400 according to various embodiments disclosed in the document may include the substrate layer 410 and the adhesive layer 430. The substrate layer 410 may be formed of a hard material to protect the display 230 from an external force. The adhesive layer 430 may attach the substrate layer 410 to the display 230. As will be described later, the substrate layer 410 may include the pattern 420 in which the multiple grooves 421 are repeated. The pattern 420 may be formed on the rear surface (e.g., the surface oriented in the −Z-direction with reference to FIG. 4) of the substrate layer 410, which is the opposite surface (e.g., the surface oriented in the +Z-direction with reference to FIG. 4) of the front surface of the substrate layer 410, which is exposed to the outside of the electronic device 200. The substrate layer 410 may have multiple micro-grooves 421 formed on the rear surface thereof, and thus may become flexible since a repulsive force thereof is reduced. In other words, in case of comparing a central area 411 (e.g., an area corresponding to second area 232 of the display 230 to be described later) of the substrate layer 410, in which the pattern 420 exists, and remaining areas 412 (e.g., areas corresponding to first areas 231 of the display 230 to be described later) except for the central area 411 of the substrate layer 410, in which the pattern 420 does not exist, the central area 411 of the substrate layer 410 may have the pattern 420 and the adhesive layer 430 made of a flexible material, which are arranged thereon, and thus may become more flexible than the remaining areas 412 of the substrate layer 410, on which the pattern 420 is not formed. Therefore, as the pattern 420 is formed on the protective film 400 disclosed in the document, it may be possible to alleviate the phenomenon in which a bending or a folding operation of the display 230 is interrupted due to a repulsive force of the substrate layer 410 in the deformation area 230C. In addition, it may be possible to alleviate or solve the phenomenon in which the display 230 is deformed due to a repulsive force of the substrate layer 410 and thus is lifted with respect to the electronic device 200. The pattern 420 formed on the substrate layer 410 will be described in detail below. According to various embodiments, the area of the central area 411 of the substrate layer 410 may be formed smaller than the area of the remaining areas 412 except for the central area 411 of the substrate layer 410.

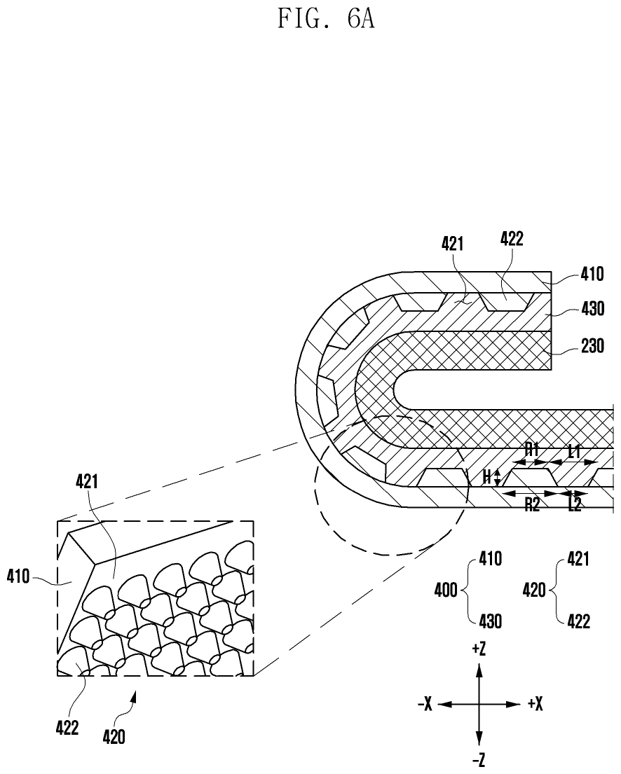

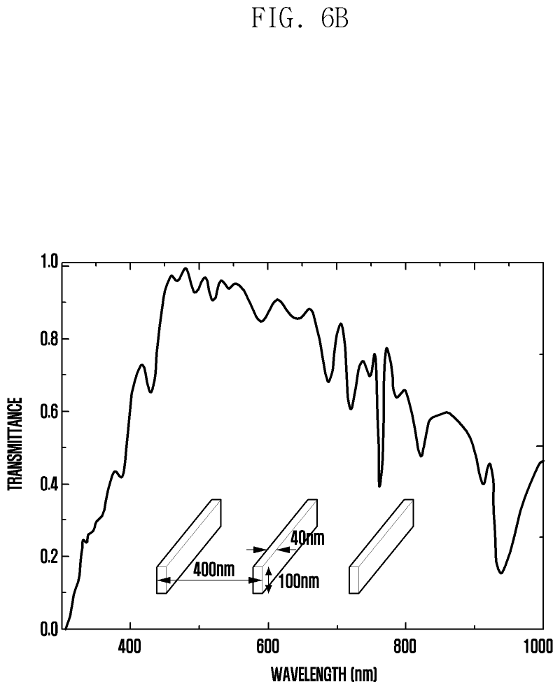

FIG. 6A is a cross-sectional view of the electronic device taken along line A-A illustrated in FIG. 2A according to an embodiment of the disclosure. FIG. 6B is a graph for explaining a relationship between a projection degree of a pattern formed on a substrate layer and a wavelength of light according to an embodiment of the disclosure.

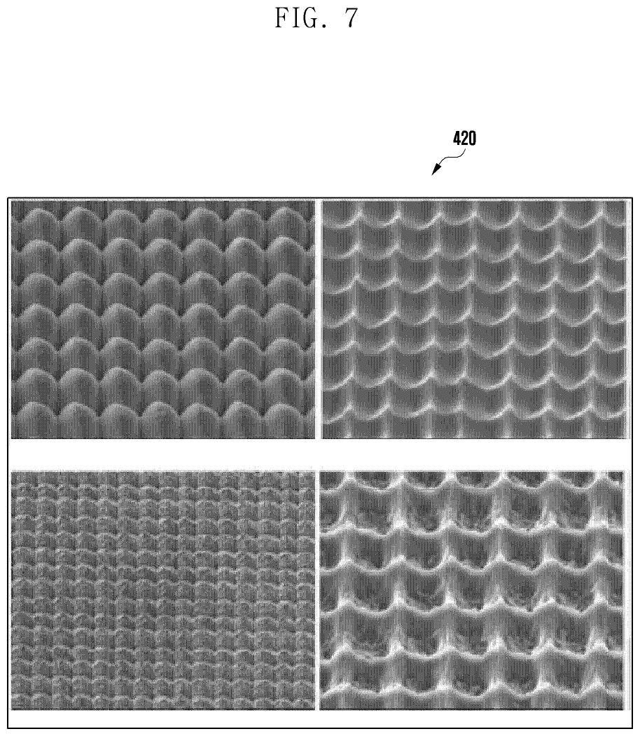

FIG. 7 is a view showing various shapes of a pattern formed on a substrate layer of a protective film according to an embodiment of the disclosure.

According to various embodiments, the protective film 400 may be configured such that the front surface of the substrate layer 410 is exposed to the outside of the electronic device 200 (e.g., the electronic device 101 in FIG. 1), and the rear surface opposite to the front surface is disposed to face the display 230 (e.g., the display module 160 in FIG. 1 or the display 230 in FIG. 2A).

Referring to FIG. 6A, the pattern 420 may be formed on the rear surface of the substrate layer 410. The pattern 420 may be formed on the rear surface of the substrate layer 410 and may have a shape in which the multiple grooves 421 are repeated. The multiple grooves 421 may be spaces concavely formed on the rear surface of the substrate layer 410. The pattern 420 may include the multiple grooves 421 and multiple protrusions 422 formed by the multiple grooves 421. The pattern 420 may have a shape in which the multiple protrusions 422 are repeated.

According to various embodiments, a repulsive force thereof may be reduced as the multiple grooves 421 constituting the pattern 420 are repeatedly formed, and thus the substrate layer 410 may become flexible.

In an embodiment, the depth H of the grooves 421 formed on the substrate layer 410 may be determined within a range which allows a repulsive force of the substrate layer 410 to be reduced to a predetermined level. In addition, the depth H of the grooves 421 may be determined within a range which allows the substrate layer 410 to maintain stiffness of a predetermined level or more. For example, the depth H of the grooves 421 may be 30% or more of the thickness in the width direction (e.g., the Z-axis direction with reference to FIG. 6A) of the substrate layer 410 in consideration of a repulsive force of the substrate layer 410, and may be less than 50% of the thickness of the substrate layer 410 in consideration of stiffness of the substrate layer 410. The above-described numerical values are merely an example, and it does not mean that the depth H of the grooves 421 is limited to the above-described numerical value. The depth H of the grooves 421 formed on the substrate layer 410 may be variously changed in consideration of a repulsive force and stiffness of the substrate layer 410.

According to various embodiments, a part of the adhesive layer 430 may be disposed in the grooves 421 formed on the substrate layer 410. The adhesive layer 430 may be disposed on the rear surface of the substrate layer 410 so as to be in close contact with the pattern 420 of the substrate layer 410, so that a part thereof is filled in the grooves 421 of the substrate layer 410. In this case, the ratio in which the central area 411, in which the grooves 421 are formed on the substrate layer 410, is occupied by the adhesive layer 430, may increase compared to those of the remaining areas 412 of the substrate layer 410 except for the central area 411. Therefore, the central area 411 of the substrate layer 410, on which the grooves 421 are formed, may have a reduced repulsive force and an improved flexibility, compared to the remaining areas 412 of the substrate layer 410, on which the grooves 421 are not formed.

In the remaining areas 412 of the substrate layer 410, on which the grooves 421 are not formed, the ratio between the substrate layer 410 and the adhesive layer 430 may be the same. Accordingly, the substrate layer 410 may secure stiffness of a predetermined level or more.

The protective film 400 according to various embodiments disclosed in the document may include the substrate layer 410 and the adhesive layer 430. The substrate layer 410 may be formed of a hard material to protect the display 230 from an external force. The pattern 420 for reducing a repulsive force of the substrate layer 410 may be formed on the substrate layer 410. Referring to FIG. 6A, the pattern 420, in which the multiple grooves 421 are repeated, may be formed on the rear surface of the substrate layer 410. The substrate layer 410 may have multiple micro-grooves 421 formed on the rear surface thereof, and thus may become flexible since the repulsive force thereof is reduced. The central area 411 of the substrate layer 410, on which the grooves 421 are formed, may have the adhesive layer 430 disposed thereon, and may be more flexible than the remaining areas 412 of the substrate layer 410, on which the groove 421 is not formed. In summary, the protective film 400 may be configured to reduce a repulsive force of the substrate layer 410 through the pattern 420 formed on the rear surface of the substrate layer 410, and to secure flexibility above a predetermined level through the adhesive layer 430 disposed on the rear surface of the substrate layer 410. Therefore, it may be possible to alleviate the phenomenon in which a bending or a folding operation of the display 230 is interrupted due to a repulsive force of the substrate layer 410 in the deformation area 230C.

In addition, as the result of the reduced repulsive force of the substrate layer 410, it may be possible to alleviate or solve the phenomenon in which the center portions of the multiple bars 251 included in the support member 250 are deformed due to a repulsive force of the substrate layer 410. Therefore, it may be possible to alleviate or solve the lifting phenomenon in which a portion of the display 230, which is coupled to the support member 250, protuberates in a specific direction compared to the other portions.

In addition, as the result that a repulsive force of the substrate layer 410 is reduced, regardless of the phenomenon that the central portion of the multiple bars 251 included in the support member 250 is deformed, it may be possible to alleviate or solve a phenomenon in which the protective film 400 and the display 230 themselves are deformed.

Referring to FIG. 6A, in case that the pattern 420 is formed on the substrate layer 410, the pattern 420 may be visually recognized by a user. For example, light incident onto the substrate layer 410 may not pass through the pattern 420 and be reflected from the pattern 420, thereby being recognized by a user. In case that the pattern 420 is recognized while the electronic device 200 is used, a user may feel uncomfortable in using the electronic device 200.

According to various embodiments disclosed in the document, the pattern 420 formed on the substrate layer 410 may be formed in nanometer (nm) size such that a phenomenon, in which the pattern 420 is recognized, is alleviated or solved.

Referring to FIG. 6B, in case that the size of the pattern is smaller than the wavelength (e.g., 300 nm-700 nm) of visible light, light incident onto the substrate layer 410 may mostly pass through the substrate layer 410 and the adhesive layer 430, so that light transmittance is improved. The degree of reflection of light, which has been incident onto the substrate layer 410, may be reduced at the boundary portion between the substrate layer 410 and the adhesive layer 430, and thus a phenomenon, in which the pattern 420 is recognized, may be alleviated.

According to various embodiments, the pattern 420 of the substrate layer 410 may include the multiple grooves 421 and the protrusions 422 convexly formed on one surface of the substrate layer 410 since the substrate layer is recessed due to the grooves. The grooves 421 and the protrusions 422 of the pattern 420 may be formed in nanometer size. In an embodiment, referring to FIG. 6B, in case that the size of the pattern 420 is formed in a size smaller than the wavelength of visible light, the transmittance of light with respect to the pattern 420 may increase. Therefore, the grooves 421 and the protrusions 422 of the pattern 420 may be formed to have a size less than or equal to the wavelength of visible light so as to increase the transmittance of light with respect to the pattern 420. In an embodiment, the widths (or gaps) L1 and L2) of the grooves 421 may have the size of a wavelength of visible light or less, and may be formed to be greater than 300 nm and smaller than 700 nm. For example, referring to FIG. 6B, the widths L1 and L2 of the grooves 421 may be 400 nm. In an embodiment, the height H at which the protrusions 422 protrude with respect to the grooves 421 and the widths (or gaps) R1 and R2 of the protrusions 422, may be the size of a wavelength of visible light or less and may be greater than 300 nm and smaller than 700 nm. For example, referring to FIG. 6B, the height H of the grooves 421 may be 100 nm, and the widths thereof may be 400 nm. The above-described numerical values are merely examples, and it may not mean that the widths of the grooves 421, the height H of the protrusions 422, and the widths R1 and R2 of the protrusions 422 are limited to the above-described numerical values. The size of the pattern 420 may be variously changed in an area of the visible light wavelength band which allows the transmittance of light with respect to the pattern 420 to be secured at a predetermined level or more.

According to various embodiments disclosed in the document, the grooves 421 and the protrusions 422 of the pattern 420 may be formed in nanometer size of a wavelength of visible light or less. In this case, it may be possible to alleviate the phenomenon in which light incident onto the substrate layer 410 is reflected from the pattern 420. Therefore, it may be possible to alleviate or solve the phenomenon in which the transmittance of light with respect to the pattern 420 is increased so that the pattern 420 is recognized by a user.

According to various embodiments, the pattern 420 may be formed in a shape which reduces the degree of reflection of light incident onto the substrate layer 410 and then reflected from the pattern 420. In an embodiment, referring to FIG. 6A, the protrusions 422 may have shapes in which the cross-sectional areas thereof decrease along a direction from the substrate layer 410 to the adhesive layer 430, such as a cone shape. In this case, the refractive index of light incident to the protrusions 422 may be continuously changed as going from the substrate layer 410 to the adhesive layer 430, and thus the degree of diffused reflection of light may be reduced in the protrusions 422.

In addition, referring to FIG. 7, the pattern 420 may be formed to have a moth-eye structure, a honeycomb structure, a hemisphere structure, a cone structure, or a cylindrical structure in order to reduce the degree of light which is incident onto the substrate layer 410 and then reflected from the pattern 420.

According to various embodiments, as the refractive index difference between the substrate layer 410 and the adhesive layer 430 increases, a phenomenon, in which light is reflected from the pattern 420 formed on the substrate layer 410, may increase. Therefore, visibility of the pattern 420 may increase. According to various embodiments disclosed in the document, a refractive index difference between the substrate layer 410 and the adhesive layer 430 may be reduced by adjusting the refractive index of the adhesive layer 430. Accordingly, visibility of the pattern 420 from the outside of the electronic device 200 may be reduced. A method of adjusting the refractive index of the adhesive layer 430 will be described in detail below.

According to various embodiments, the refractive index difference between the substrate layer 410 and the adhesive layer 430 may be adjusted in various methods. In an embodiment, the refractive index difference between the substrate layer 410 and the adhesive layer 430 may be reduced through adjusting the refractive index of the adhesive layer 430. In an embodiment, the refractive index of the adhesive layer 430 may be changed by adjusting a ratio of a solute and a solvent constituting the adhesive layer 430. For example, a solute or a solvent for adjusting the refractive index thereof may be mixed in or added to the adhesive layer 430. In an embodiment, a refractive index adjustment member 440 for reducing a refractive index difference with the substrate layer 410 may be mixed in the adhesive layer 430. The refractive index adjustment member 440 may be a solute such as a solid filler, or a solvent such as deionized (DI) water. The solid filler may be formed of a silica-based material.

In case that the refractive index of the adhesive layer 430 is lower than the refractive index of the substrate layer 410, a material for increasing the refractive index of the adhesive layer 430 may be mixed in the adhesive layer 430. In an embodiment, referring to FIG. 7, a solid filler having a refractive index higher than the refractive index of the adhesive layer 430 may be mixed in the adhesive layer 430. In this case, the refractive index of the adhesive layer 430 may be increased than that of the existing adhesive layer, and thus may become substantially the same as the refractive index of the substrate layer 410. In some embodiments, the refractive index of the adhesive layer 430 may be increased by reducing a solvent (e.g., DI water) in comparison with a solute of the adhesive layer 430. In this case, the refractive index of the substrate layer 410 and the refractive index of the adhesive layer 430 may become substantially the same. Therefore, the refractive index difference between the substrate layer 410 and the adhesive layer 430 may be reduced, and thus it may be possible to increase the transmittance of light with respect to the pattern 420 formed on the substrate layer 410. Therefore, it may be possible to reduce visibility of the pattern 420 from the outside of the electronic device 200.

In case that the refractive index of the adhesive layer 430 is higher than the refractive index of the substrate layer 410, a material for decreasing the refractive index of the adhesive layer 430 may be mixed in the adhesive layer 430. In an embodiment, a solid filler having a refractive index lower than the refractive index of the adhesive layer 430 may be mixed in the adhesive layer 430. In this case, the refractive index of the adhesive layer 430 may be decreased than that of the existing adhesive layer, and thus may become substantially the same as the refractive index of the substrate layer 410. In some embodiments, the adhesive layer 430 may be configured such that the refractive index of the adhesive layer 430 is reduced by increasing the ratio of a solvent in comparison with a solute constituting the adhesive layer 430. For example, the adhesive layer 430 may have DI water mixed therein to reduce a refractive index thereof. In this case, the refractive index of the adhesive layer 430 may be decreased than that of the existing adhesive layer, and thus may become substantially the same as the refractive index of the substrate layer 410. Therefore, the refractive index difference between the substrate layer 410 and the adhesive layer 430 may be reduced, and thus it may be possible to increase the transmittance of light with respect to the pattern 420 formed on the substrate layer 410. Therefore, it may be possible to reduce visibility of the pattern 420 from the outside of the electronic device 200.

According to various embodiments disclosed in the document, the pattern 420 for reducing a repulsive force of the substrate layer 410 may be formed on the substrate layer 410. The pattern 420 formed on the substrate layer 410 may be formed in nanometer size such that the phenomenon, in which the pattern 420 is recognized from the outside of the electronic device 200, is alleviated or solved. Preferably, the pattern 420 may be formed in a size between 300 nm-700 nm which is a visible light wavelength band. In this case, light incident onto the substrate layer 410 may pass through the pattern 420 without being reflected from the pattern 420. Therefore, as the result of increasing the transmittance of light with respect to the pattern 420, it may be possible to alleviate or solve the phenomenon in which the pattern 420 is visually recognized from the outside of the electronic device 200.

Meanwhile, as the refractive index difference between the substrate layer 410 and the adhesive layer 430 increases, a phenomenon, in which light is reflected from the pattern 420 formed on the substrate layer 410, may increase. The refractive index adjustment member 440 (e.g., a solid filler or DI water) for reducing the refractive index difference between the substrate layer 410 and the adhesive layer 430 may be mixed in the adhesive layer 430. The refractive indices of the substrate layer 410 and the adhesive layer 430 may become substantially the same since the refractive index difference therebetween is reduced by the refractive index adjustment member 440 mixed in the adhesive layer 430. Therefore, it may be possible to alleviate or solve the phenomenon in which light is reflected from the pattern 420 formed on the substrate layer 410. Therefore, it may be possible to alleviate or solve the phenomenon in which the pattern 420 is recognized from the outside of the electronic device 200 since the transmittance of light with respect to the pattern 420 is increased.

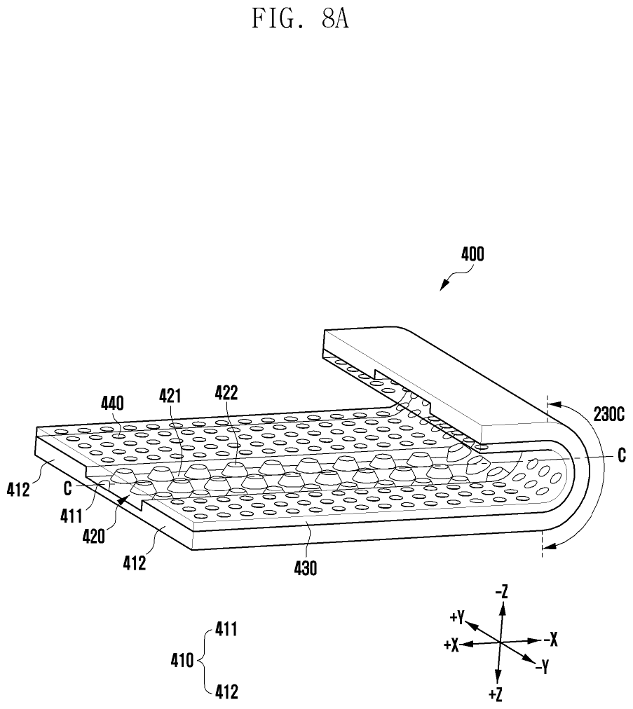

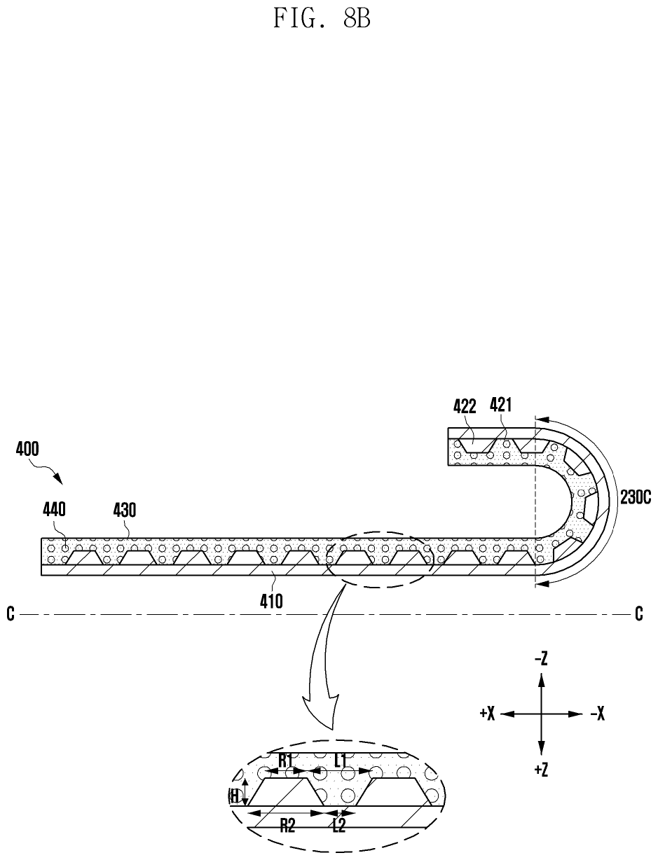

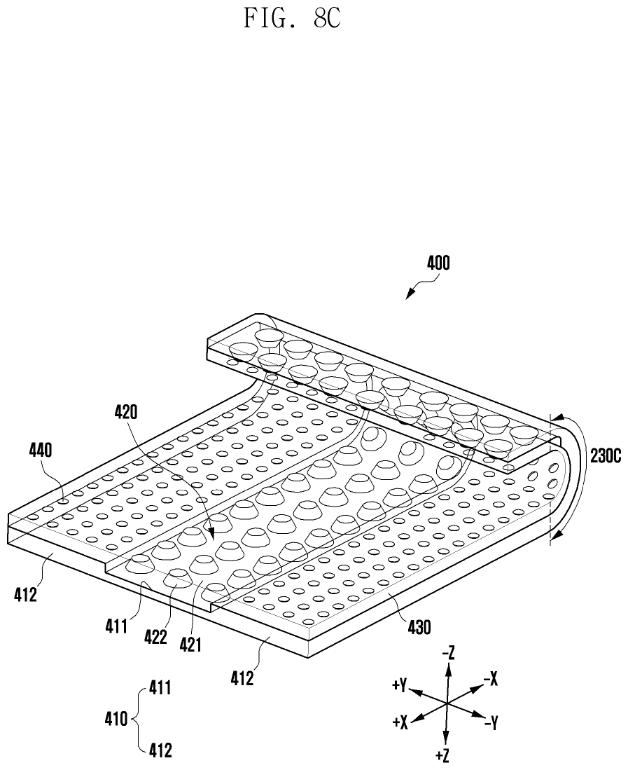

FIG. 8A is a rear perspective view of a protective film according to an embodiment of the disclosure. FIG. 8B is a cross-sectional view of the protective film taken along line C-C illustrated in FIG. 8A according to an embodiment of the disclosure. FIG. 8C is a rear perspective view of the protective film 40 illustrated in FIG. 8A and a protective film of an embodiment according to an embodiment of the disclosure.

According to various embodiments, the display 230 (e.g., the display module 160 in FIG. 1 or the display 230 in FIG. 2A) may be coupled to the support member 250 (e.g., the support plate 350 in FIG. 4), and may be supported by the support member 250. Opposite ends of the support member 250 may be arranged in the guide rails 260. For example, as described above, both ends of the multiple bars 251 included in the support member 250 may be inserted into the guide rails 260, respectively, so that sliding of the support member 250 is guided. Opposite ends of the display 230 may be arranged on opposite ends of the support member 250 to be supported by the support member 250. Accordingly, opposite ends of the display 230 may be supported through opposite ends of the support member 250 and thus fixed to the guide rails 260. Hereinafter, areas of the display 230 as first areas 231 (the first areas 231 in FIG. 2A) in which opposite ends thereof are fixed to the guide rails 260 and the second area 232 (e.g., the second area 232 in FIG. 2A) except for the first areas 231 will be described. Here, the first areas 231 may be areas corresponding to both ends of the multiple bars 251 of the support member 250, and the second area 232 may be an area corresponding to the central part of the multiple bars 251. In addition, the first areas 231 may be areas corresponding to the remaining areas 412 of the substrate layer 410, on which the pattern 420 is not formed, and the second area 232 may be an area corresponding to the central area 411 of the substrate layer 410, on which the pattern 420 is formed. However, the first areas 231 and the second area 232 are merely divided for convenience of description, and it may not mean that the display 230 is physically divided into the first areas 231 and the second area 232.

In case that the pattern 420 is not formed on the central area 411 of the substrate layer 410, a repulsive force of the substrate layer 410 may deform the central portion of the multiple bars 251 included in the support member 250. Accordingly, the second area 232 of the display 230 coupled to the support member 250 may be deformed and thus a lifting phenomenon may occur. For example, referring to FIG. 5, since both ends of the multiple bars 251 are fixed to the guide rails 260, a repulsive force of the substrate layer 410 may be concentrated on the central portion of the multiple bars 251, and thus the central portion of the multiple bars 251 may be convexly curved in one direction. Therefore, the lifting phenomenon in which the second area 232 of the display 230 supported by the multiple bars 251 protuberates convexly in a specific direction compared to the other portions may occur. On the contrary, both ends of the multiple bars 251 may not be deformed due to being fixed to the guide rails 260. Therefore, the first areas 231 of the display 230, which are supported at both ends of the multiple bars 251, may be maintained flat without being deformed.

According to various embodiments, the pattern 420 formed on the substrate layer 410 may be positioned on the second area 232 of the display 230, which corresponds to the central portion of the multiple bars 251 configured so as not to bend in one direction.

Referring to FIGS. 8A and 8B, the pattern 420 of the substrate layer 410 may be formed on the central area 411 of the substrate layer 410, which corresponds to the second area 232 of the display 230. The pattern 420 may extend in a direction parallel to the sliding direction (e.g., the X-axis direction with reference to FIG. 8A) thereof on the central area 411 of the substrate layer 410, and may be positioned in a part of the deformation area 230C of the display 230, which corresponds to the central area 411 of the substrate layer 410. A repulsive force of the central area 411 of the substrate layer 410 may be reduced by the pattern 420. Therefore, the stress due to a repulsive force of the substrate layer 410 may not be concentrated on the central portion of the multiple bars 251, which corresponds to the second area 232 of the display 230, and thus the central portion of the multiple bars 251 may not be deformed. Accordingly, it may be possible to alleviate or solve the lifting phenomenon of the second area 232 of the display 230 supported by the multiple bars 251.

According to various embodiments, the pattern 420 of the substrate layer 410 may be positioned on the deformation area 230C of the display 230. The pattern 420 of the substrate layer 410 may be formed on one area of the substrate layer 410, which corresponds to the deformation area 230C of the display 230.

Referring to FIG. 8C, the pattern 420 of the substrate layer 410 may extend in a direction perpendicular to the sliding direction (e.g., the Y-axis direction with reference to FIG. 8C) thereof on one area of the substrate layer 410, which corresponds to the deformation area 230C of the display 230. For example, the pattern 420 of the substrate layer 410 may have the shape of “T” in case that the substrate layer 410 is seen in the +Z-direction with reference to FIG. 8C. A repulsive force of one area of the substrate layer 410, which corresponds to the deformation area 230C of the display 230, may be reduced by the pattern 420. Accordingly, deformation due to a repulsive force of the substrate layer 410 may be reduced in the multiple bars 251 corresponding to the deformation area 230C of the display 230. Accordingly, it may be possible that the lifting phenomenon of the deformation area 230C of the display 230, which is supported by the multiple bars 251, is reduced.

According to various embodiments, as illustrated in FIGS. 8A to 8C, the pattern 420 may be positioned on the second area 232 and the deformation area 230C of the display 230 in case of being seen in the direction (e.g., the −Z-direction with reference to FIG. 8A) of the adhesive layer 430 on the substrate layer. The pattern 420 of the substrate layer 410 may not be positioned on the first areas 231 of the display 230, and thus it may be possible that the phenomenon, in which the pattern 420 is visually recognized from the outside of the electronic device 200 (e.g., the electronic device 101 in FIG. 1), does not occur. Differently therefrom, the pattern 420 of the substrate layer 410 may be positioned on the second area 232 and the deformation area 230C of the display 230, and thus it may be possible that the phenomenon, in which the pattern 420 is visually recognized from the outside of the electronic device 200, occurs. In relation to the phenomenon, as previously described in FIGS. 6A, 6B, and 7, the refractive indices of the substrate layer 410 and the adhesive layer 430 may be substantially identically matched through the refractive index adjustment member 440 so as to secure transmittance with respect to light.

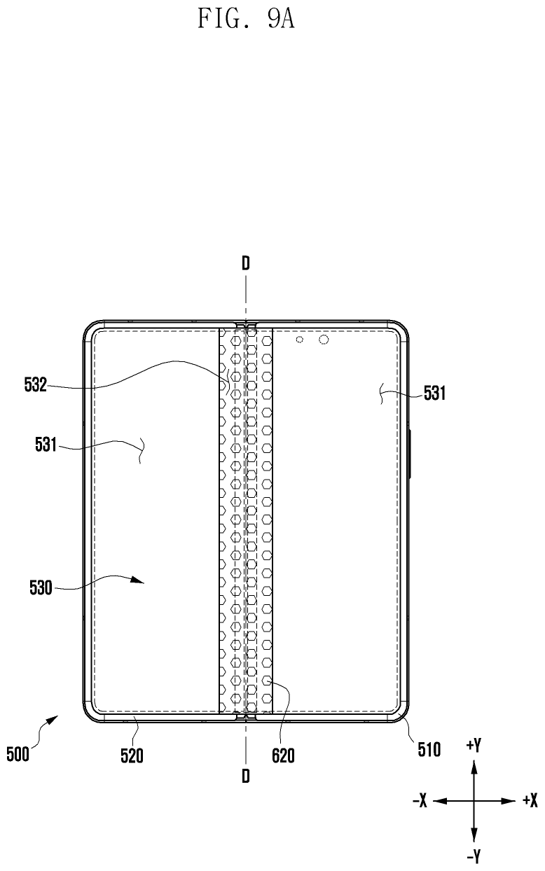

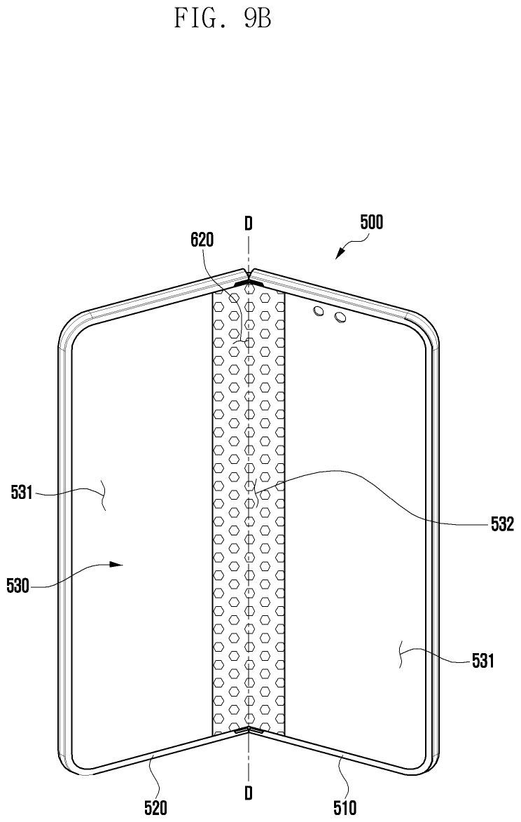

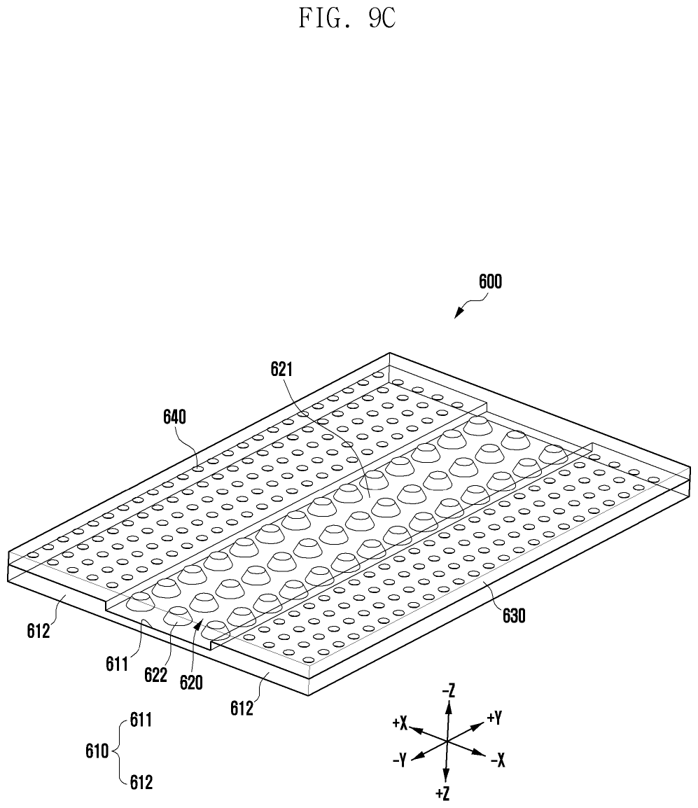

FIG. 9A is a view showing an unfolded state of an electronic device according to an embodiment of the disclosure. FIG. 9B is a view showing an intermediate state between an unfolded state and a folded state of the electronic device according to an embodiment of the disclosure. FIG. 9C is a rear perspective view of the protective film for protecting a display illustrated in FIG. 9A according to an embodiment of the disclosure.

An electronic device 500 to be described below may be a foldable electronic device 500 including a display 530 which is foldable with reference to a folding axis D-D of a hinge device as a form factor electronic device 500 different from the electronic device 200 described in FIGS. 2A to 2C, 3A, 3B, and 4.

In the below description, in connection with elements which are identical or similar to elements described in FIGS. 2A, 2B, 2C, 3A, 3B, 4, 5, 6A, 6B, 7, 8A, 8B, and 8C, the same member numbers may be used, and detailed descriptions thereof may be omitted.

According to various embodiments, the electronic device 500 illustrated in FIGS. 9A and 9B may be configured to be foldable. The electronic device 500 may include a first housing 510 and a second housing 520 which are connected to be foldable. The first housing 510 and the second housing 520 may be foldably connected through a hinge device (not shown). In an embodiment, the first housing 510 and the second housing 520 may be folded with reference to the folding axis D-D of a hinge device. The first housing 510 and the second housing 520 may be arranged at both sides with reference to the folding axis D-D, and may be an overall symmetrical shape with respect to the folding axis D-D. In some embodiments, the first housing and the second housing may be folded asymmetrically with reference to the folding axis D-D.

According to various embodiments, the first housing 510 and the second housing 520 may be connected to be foldable by a hinge device.

Referring to FIGS. 9A and 9B, according to the degree of rotation between the first housing 510 and the second housing 520 by the hinge device, a state of the electronic device may be change into an “unfolded state” in which the electronic device 500 is in an unfolded state, a “folded state” in which the electronic device 500 is in a folded state, and an “intermediate state” which is an intermediate state between the unfolded state and the folded state. Therefore, the electronic device 500 may be configured such that the first housing 510 and the second housing 520 are folded or unfolded through the hinge device, and thus the electronic device 500 may be changed from an unfolded state to a folded state, or from a folded state to an unfolded state.

According to various embodiments, the electronic device 500 may include the display 530 (e.g., the display 230 in FIG. 2A) supported by the first housing 510 and the second housing 520. The display 530 of the electronic device 500 illustrated in FIGS. 9A and 9B may include substantially the same configurations as those of the display 230 described above in FIG. 4. The display 530 may include all various devices capable of displaying visual information. In an embodiment, the display 530 may include a deformation area 532 which is folded together as the first housing 510 and second housing 520 are folded. At least a part of the deformation area 532 of the display 530 may be folded by folding of the first housing 510 and the second housing 520.

According to various embodiments, a protective film 600 may be disposed on the window layer 310 of the display 530. Here, the protective film 600 may include substantially the same configurations as those of the protective film 400 described above in FIGS. 6A, 6B, and 7. The protective film 600 may be disposed on the window layer 310 to protect the display 530 from an external force.

In addition, in case that the display 530 is folded as the first housing 510 and the second housing 520 are folded with reference to the folding axis D-D, the protective film 600 stacked on the display 530 may be folded together with the display 530. In this case, a repulsive force to be restored to the original shape thereof may be generated in a substrate layer 610 of the protective film 600. A repulsive force generated in the substrate layer 610 may interrupt a folding operation of the first housing 510 and the second housing 520. For example, the gaps between the first housing 510 and the second housing 520 of the electronic device 500 may be spaced due to a repulsive force of the substrate layer 610 in a folded state.

The protective film 600 according to various embodiments disclosed in the document may include the substrate layer 610 and an adhesive layer 630. The substrate layer 610 may be formed of a hard material to protect the display 530 from an external force. A pattern 620 for reducing a repulsive force of the substrate layer 610 may be formed on the substrate layer 610. Referring to FIG. 9C, a pattern 620, in which multiple micro-grooves 621 are repeated, may be formed on the rear surface of the substrate layer 610. In an embodiment, referring to FIG. 9C, the pattern 620 may be formed on a central area 611 of the substrate layer 610, and the pattern 620 may not be formed on remaining areas 612 except for the central area 611. The substrate layer 610 may have multiple micro-grooves 621 formed on the rear surface (e.g., the surface oriented in the −Z-direction with reference to FIG. 9C) thereof so as to reduce the repulsive force thereof, and thus may become flexible. In addition, the adhesive layer 630 may be disposed in the micro-grooves 621 formed on the substrate layer 610, and the central area 611 of the substrate layer 610, on which the pattern 620 is formed, may become more flexible than the remaining areas 612 except for the central area 611. In summary, the protective film 600 may be configured to reduce a repulsive force of the substrate layer 610 through the pattern 620 formed on the rear surface of the substrate layer 610, and to secure flexibility above a predetermined level through the adhesive layer 630 disposed on the rear surface of the substrate layer 610. Particularly, the central area 611 of the substrate layer 610 may have a higher ratio occupied by the adhesive layer 630 than the remaining areas 612, and thus may be more flexible than the remaining areas 612 of the substrate layer 610. Therefore, it may be possible to alleviate or solve the phenomenon in which the repulsive force generated in the substrate layer 610 interrupts the folding operation of the first housing 510 and the second housing 520 in the deformation area 532 of the display 530.

According to various embodiments, the pattern 620 formed on the substrate layer 610 may be positioned on the deformation area 532 of the display 530. In an embodiment, the pattern 620 may be formed on the central area 611 of the substrate layer 610, which corresponds to the deformation area 532 of the display 530. The pattern 620 may extend in a direction parallel to the folding axis D-D (e.g., the Y-axis direction with reference to FIG. 9C) on the central area 611, and may be positioned on the deformation area 532 of the display 530. A repulsive force of the central area 611 of the substrate layer 610 may be reduced as the pattern 620 is formed. Therefore, it may be possible to alleviate or solve the phenomenon in which the folding operation of the first housing 510 and the second housing 520 is interrupted on the deformation area 532 of the display 530. In addition, it may be possible to alleviate or solve the phenomenon in which the protective film 400 and the display 530 is bent or lifted on the deformation area 532 due to a repulsive force of the substrate layer 410.

According to various embodiments, as illustrated in FIG. 9C, the pattern 620 may be positioned on the deformation area 532 of the display 530 in case of being seen in the direction (e.g., the −Z-direction with reference to FIG. 9C) of the adhesive layer 630 on the substrate layer 610. The pattern 620 of the substrate layer 610 may not be positioned on remaining areas 531 except for the deformation area 532 of the display 530, and thus the phenomenon, in which the pattern 620 is recognized from the outside of the electronic device 500, may not occur. Differently therefrom, the pattern 620 of the substrate layer 610 may be positioned on the deformation area 532 of the display 530, and thus it may be possible that the phenomenon, in which the pattern 620 is recognized from the outside of the electronic device 500, occurs. In relation to the phenomenon, as previously described in FIGS. 6A, 6B, and 7, the pattern 620 may be formed in nanometer size of a visible light wavelength band, a refractive index adjustment member 640 may be mixed to the adhesive layer 630, and thus the refractive indices of the substrate layer 610 and the adhesive layer 630 may be substantially identically matched so as to secure transmittance with respect to light.

The above-described protective films 400 and 600 may also be applied to a display module of a bar type electronic device, in addition to the slidable electronic device 200 illustrated in FIGS. 2A to 2C, 3A, and 3B and the foldable electronic device 500 illustrated in FIGS. 9A and 9B. In an embodiment, the protective film 400 or 600 may be disposed on an unbreakable (UB) type OLED display (e.g., a curved display module) (e.g., the display module 160 in FIG. 1). The pattern 420 or 620 may be formed on one area of the substrate layer 410 or 610, which corresponds to a portion in which a curvature of the display is formed. Therefore, the protective film 400 or 600 may protect the display from an external force since the substrate layer 410 or 610 is formed of a hard material, and may be disposed in a portion in which a curvature of the display is formed since a repulsive force is reduced due to the pattern 420 or 620.

An electronic device (e.g., the electronic device 101 in FIG. 1, the electronic device 200 in FIG. 2A, and/or the electronic device 500 in FIG. 9A) according to various embodiments disclosed in the document may include a first housing (e.g., the first housing 210 in FIG. 2A or the first housing 510 in FIG. 9A), a second housing (e.g., the second housing 220 in FIG. 2A or the second housing 520 in FIG. 9A) connected to the first housing such that a relative position thereof with respect to the first housing is changeable, a display (e.g., the display module 160 in FIG. 1, the display 230 in FIG. 2A, or the display 530 in FIG. 9A) including the window layer 310 and the display panel 330 disposed under the window layer and including a deformation area (e.g., the deformation area 230C in FIGS. 3A and 3B or the deformation area 532 in FIG. 9A) deformed as the relative position between the first housing and the second housing is changed, the substrate layer 410 or 610 which includes the pattern 420 or 620 in which multiple protrusions 422 or 622 repeat and is disposed above the window layer, and the adhesive layer 430 or 630 which is disposed between the window layer and the substrate layer such that at least a part thereof is disposed between the protrusions of the substrate layer, and has the refractive index adjustment member 440 or 640 mixed therein in order to reduce a refractive index difference with the substrate layer.

In addition, the refractive index of the adhesive layer and the refractive index of the substrate layer may be substantially identical to each other.

In addition, the refractive index adjustment member may include a solid filler.

In addition, the widths R1 and R2 of the protrusions may have a nanometer size.

In addition, each of the protrusions may have a width of 300 nm to 700 nm.

In addition, the protrusions may have cross-sectional areas decreasing along a direction from the substrate layer to the adhesive layer.

In addition, the first housing may be coupled to be slidable with respect to the second housing, at least a part of the display may be inserted into the accommodation space 280 of the electronic device or withdrawn from the accommodation space according to sliding of the second housing, and the deformation area 230C of the display may be an area deformed by sliding of the first housing with respect to the second housing.

In addition, the support member 250 (e.g., the support plate 350 in FIG. 4) which supports the display and of which at least a part is disposed in the second housing to slide with respect to the first housing, and guide rails 260 arranged on opposite ends of the support member to guide sliding of the support member, may be included therein, and the display may include first areas 231 of which opposite ends are fixed to the guide rails, and the second area 232 except for the first area, and the pattern of the substrate layer may be formed on one area (e.g., the central area 411) of the substrate layer, which corresponds to the second area of the display.

In addition, the pattern of the substrate layer may extend in a direction (e.g., the X-axis direction in FIG. 3A) parallel to the sliding direction of the electronic device on the second area of the display.

In addition, the pattern of the substrate layer may be positioned on the deformation area.

In addition, a hinge device, which is configured to connect the first housing and the second housing so as to be foldable with reference to a folding axis (e.g., the D-D axis in FIG. 9A), may be included therein, and the deformation area of the display may be deformed by folding between the first housing and the second housing.

In addition, the pattern of the substrate layer may be positioned on the deformation area and extend in a direction (e.g., the Y-axis direction with reference to FIG. 9A) parallel to the folding axis of the hinge device.

In addition, the adhesive layer may be formed of at least one material among an acrylic-based material, a silicone-based material, a rubber-based material, and a urethane-based material.

The protective film 400 or 600 disposed on a display (e.g., the display module 160 in FIG. 1, the display 230 in FIG. 2A, or the display 530 in FIG. 9A) of an electronic device (e.g., the electronic device 101 in FIG. 1, the electronic device 200 in FIG. 2A, and/or the electronic device 500 in FIG. 9A) according to various embodiments disclosed in the document may include the substrate layer 410 which includes the pattern 420 or 620 in which multiple protrusions 422 or 622 repeat and is disposed above the window layer 310 of the display, and the adhesive layer 430 or 630 which is disposed between the window layer and the substrate layer such that at least a part thereof is disposed between the protrusions of the substrate layer, and has the refractive index adjustment member 440 or 640 mixed therein in order to reduce a refractive index difference with the substrate layer.

In addition, the refractive index of the adhesive layer and the refractive index of the substrate layer may be substantially identical to each other.

In addition, the refractive index adjustment member may include a solid filler.

In addition, the widths R1 and R2 of the protrusions may have a nanometer size.

In addition, each of the protrusions may have a width of 300 nm to 700 nm.

In addition, the protrusions may have cross-sectional areas decreasing along a direction from the substrate layer to the adhesive layer.

In addition, the display may include a deformation area (e.g., the deformation area 230C in FIGS. 3A and 3B or the deformation area 532 in FIG. 9A) deformed as a relative position between a first housing (e.g., the first housing 210 in FIG. 2A or the first housing 510 in FIG. 9A) and a second housing (e.g., the second housing 220 in FIG. 2A or the second housing 520 in FIG. 9A), which are connected such that the relative position therebetween is changeable, is changed, and at least a part of the pattern of the substrate layer may be positioned on the deformation area.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a first housing;
a second housing connected to the first housing, a relative position of the second housing being changeable with respect to the first housing;
a display comprising:
a window layer, and
a display panel disposed under the window layer, the display panel comprising a deformation area deformed as the relative position between the first housing and the second housing is changed;
a substrate layer disposed above the window layer and comprising a pattern in which multiple protrusions repeat; and
an adhesive layer disposed between the window layer and the substrate layer, at least a part of the adhesive layer being disposed between the multiple protrusions of the substrate layer and having a refractive index adjustment member mixed therein in order to reduce a refractive index difference with the substrate layer.

2. The electronic device of claim 1, wherein a refractive index of the adhesive layer and a refractive index of the substrate layer are substantially identical to each other.

3. The electronic device of claim 1, wherein the refractive index adjustment member comprises a solid filler.

4. The electronic device of claim 1, wherein widths of the multiple protrusions have a nanometer size.

5. The electronic device of claim 4, wherein each of the multiple protrusions has a width of 300 nanometers (nm) to 700 nm.

6. The electronic device of claim 1, wherein the multiple protrusions have cross-sectional areas decreasing along a direction from the substrate layer to the adhesive layer.

7. The electronic device of claim 1,
wherein the first housing is slidable with respect to the second housing,
wherein at least a part of the display is inserted into an accommodation space of the electronic device or withdrawn from the accommodation space according to a sliding of the second housing, and
wherein the deformation area of the display comprises an area deformed by a sliding of the first housing with respect to the second housing.

8. The electronic device of claim 7, further comprising:
a support member supporting the display, at least a part of the support member being disposed in the second housing to slide with respect to the first housing; and
guide rails arranged on opposite ends of the support member to guide a sliding of the support member,
wherein the display further comprises a first area in which opposite ends of the display are fixed to the guide rails and a second area other than the first area, and
wherein the pattern of the substrate layer is formed on one area of the substrate layer corresponding to the second area of the display.

9. The electronic device of claim 8, wherein the pattern of the substrate layer extends in a direction parallel to a sliding direction of the electronic device on the second area of the display.

10. The electronic device of claim 9, wherein the pattern of the substrate layer is positioned on the deformation area.

11. The electronic device of claim 1, further comprising:
a hinge device connecting the first housing to the second housing to be foldable with respect to a folding axis,
wherein the deformation area of the display is deformed by a folding between the first housing and the second housing.

12. The electronic device of claim 11, wherein the pattern of the substrate layer is positioned on the deformation area and extends in a direction parallel to the folding axis of the hinge device.

13. The electronic device of claim 1, wherein the adhesive layer is formed of at least one material among an acrylic-based material, a silicone-based material, a rubber-based material, or a urethane-based material.

14. A protective film disposed on a display of an electronic device, the protective film comprising:
a substrate layer disposed above a window layer of the display and comprising a pattern in which multiple protrusions repeat; and
an adhesive layer disposed between the window layer and the substrate layer, at least a part of the adhesive layer being disposed between the multiple protrusions of the substrate layer and having a refractive index adjustment member mixed therein in order to reduce a refractive index difference with the substrate layer.

15. The protective film of claim 14, wherein a refractive index of the adhesive layer and a refractive index of the substrate layer are substantially identical to each other.

16. The protective film of claim 14, wherein the refractive index adjustment member comprises a solid filler.

17. The protective film of claim 14 wherein widths of the multiple protrusions have a nanometer size.

18. The protective film of claim 17, wherein each of the multiple protrusions has a width of 300 nanometers (nm) to 700 nm.

19. The protective film of claim 14, wherein the multiple protrusions have cross-sectional areas decreasing along a direction from the substrate layer to the adhesive layer.

20. The protective film of claim 14,
wherein the display comprises a deformation area that is deformed as a relative position between a first housing and a second housing changes, the first housing and the second housing being connected such that the relative position therebetween is changeable, and
wherein at least a part of the pattern of the substrate layer is positioned on the deformation area.
